(19) United States
(12) Patent Application Publication
(10) Pub. No.: US 2007/0103052 A1
(43) Pub. Date: May 10, 2007

(54) Field emission display device

(75) Inventors: Jian-Min Jeng, Taipei City (TW); Jeng-Maw Chiou, Hsinchu (TW); Cheng-Feng Lin, Hsinchu (TW); Ling-Ko Chang, Hsinchu (TW)

Correspondence Address: BACON & THOMAS, PLLC, 625 SLATERS LANE, FOURTH FLOOR, ALEXANDRIA, VA, 22314, US

(73) Assignees: Tatung Company, Taipei City (TW); Industrial Technology Research Institute, Hsinchu (TW)

(21) Appl. No.: 11/497,313

(22) Filed: Aug. 2, 2006

(30) Foreign Application Priority Data
Nov. 4, 2005 (TW) 094138830

(51) Int. Cl. H01J 63/04; H01J 1/62

(52) U.S. Cl. 313/497

(57) ABSTRACT

A field emission device (FED) includes a top substrate having a fluorescent layer and an anode electrode, a bottom substrate, at least one cathode electrode having a platform and at least one protrusion, an insulating layer having an opening-pattern or groove-pattern, at least one gate layer located on the insulating layer, and an electron emitter located on the protrusion of the cathode electrode, where the electron emitter can act as side emission of electrons. Each of the platform and the protrusion have a height different from each other, and that the protrusion is located in the opening of the insulating layer. Through the structure illustrated above, uniformity of emitting electron density can be improved and brightness and contrast of color for the FED can be enhanced.

### BACKGROUND OF THE INVENTION

1. Field of the Invention

The present invention relates to field emission display devices, particularly to a field emission display device adapted to side emission of electrons.

2. Description of Related Art

Display devices have become especially important in modem life, where televisions, cellular phones, personal digital assistants (PDA), digital cameras, personal computers or the Internet, rely on controlling displays to transmit information. In contrast to the traditional Cathode Ray Tube (CRT) displays, flat panel display devices are superior as lightweight, compact, and friendly to human health. However, there are still problems to be solved in terms of viewing angle, brightness, power consumption, etc.

Among newly developed technologies for flat panel display devices, a field emission display (FED) has some merits on high definition, good image quality like a CRT display and unlike liquid crystal displays which are found to have shortcomings in a narrower viewing angle, a smaller working temperature range, and a long response time. The FED has advantages in high production rate, a short response time, an excellent displaying performance, a brightness over 100 ftL, a lighter and thinner structure, a broader viewing angle, a wide working temperature range, a higher action efficiency, and good askew direction recognizing, etc. .

Further, an FED does not need a backlight module, and an outstanding brightness can be obtained even under outdoor sunshine. Following the development of nanotechnology, it improves the new electronic emission materials research for FED and forms a hot research and development direction. A carbon nanotube—field emission display (CNT-FED), which emission electrons by turnnelling effect, replace an electronic point emission component. For this reason, an FED has been considered competitive with an LCD, or even a substitute for an LCD in the future.

The working principle of an FED is similar with that of a traditional CRT, where a luminescence is produced by cathode electrons when they are “pulled out” from the points of cathode electrodes in a strong electric field with a 10⁻⁶ torr vacuum condition, and are accelerated by a positive anode voltage to excite fluorescent material on the anode plate. Accordingly, the electric field strength directly affects the number of electrons emitted from the cathode electrodes. In other words, the greater electric field strength, the higher quantity of electrons emitted from the cathode electrodes. Consequently, in the case where the electric field strength disperse non-uniformly, a problem of non-uniform distribution of electron emitters will occur. Therefore, the quality of an FED will suffer from non-uniform brightness, low contrast, and inferior glow stability.

Since every pixel of an FED possesses itself a corresponding electron emitter array, and since an electron emitter emits electrons between a cathode electrode and an gate electrode under a biased voltage, it is a significant issue in producing FEDs with a low-cost printing manufacturing process so as to precisely control the distance between the emitter and the gate electrode, and to uniformly emit electrons from an electron-emitting substrate.

Given the above, an FED with uniform distribution of electron emitters is presently an urgent need so as to improve the problems of non-uniform brightness, low contrast, and inferior production rate inherent in a low-cost FED due to non-uniform electron emission.

### SUMMARY OF THE INVENTION

The object of the present invention is to provide a field emission display device (FED), having merits in controlling electron emitters and gate electrodes at the same elevation so as to solve the problem of non-uniform electron emission, and to improve the uniformity of brightness and the contrast of color. Further, an improved structure of the present invention can simplify the manufacturing process, making a better production rate achievable.

The present invention is to provide a field emission device including a top substrate having a fluorescent layer and an anode electrode, a bottom substrate, at least one cathode electrode having a platform and at least one protrusion, an insulating layer having an opening-pattern, at least one gate electrode located on the insulating layer, and at least one electron emitter located on the protrusion of the cathode electrode.

According to the present invention, the cathode electrode is disposed on a bottom panel, and the insulating layer having the opening-pattern is located on the platform of the cathode electrode, where the opening-pattern of the insulating layer includes at least one opening. Further, the platform and the protrusion of the cathode electrode have a height different from each other, where the protrusion of the cathode electrode is located inside the opening of the insulating layer. Thereby the FED according to the present invention can control accurately the variation of voltage applied between the cathode electrode and the gate electrode, such that each electron emitter can emit accurately electrons so as to solve the problem of non-uniform emission of electrons, and to improve the uniformity of brightness and contrast of color.

In an FED according to the present invention, the way as to how the openings are arranged for the insulating layer is not limited, but preferably is a formation of matrix M×N, where M and N are each an integer greater than zero. Besides, the shape of the openings for the insulating layer is not to be limited, but preferably is a square, circle, polygon, or ellipse. In addition to the above-mentioned opening-pattern of the matrix, the opening-pattern of the insulating layer according to the present invention can be at least one groove, where the grooves can be arranged, preferably, to be parallel to a surface of the platform of the cathode electrode.

Further, the elevation of the protrusion of the cathode electrode filled in the opening of the insulating layer is not limited, and preferably the protrusion of the cathode electrode can fully fill in the opening of the insulating layer. In one of the embodiments of the present invention, the surface of the insulating layer has an elevation substantially the same as that of the surface of the protrusion of the cathode electrode.

In the present invention the electron emitter is located on the protrusion of the cathode electrode, and the gate electrode is located on the insulating layer having an opening-pattern. In the case where the surface of the protrusion of the cathode has an elevation the same as that of the surface of the insulating layer, the electron emitter and the gate electrode will be at the same elevation. That is to say, the setback of non-uniform elevation encountered by a conventional printing process can be avoided. As such, the elevations of the electron emitter and the gate electrode, as well as the driving distance between the electron emitter and the gate electrode, can be controlled accurately. In other words, the electron emitter according to the present invention can act as side emission of electrons so as to control accurately the variation of voltage applied between the cathode electrode and the gate electrode, and to enhance a uniformity of electron emission for each individual electron emitter.

In the FED according to the present invention, the platform and the protrusion of the cathode electrode can be of the same or different electric-conductive materials. The platform quantity corresponding to the protrusion(s) is not to be limited. In one of the embodiments of the present invention, one platform corresponds to a plurality of protrusions; and in another embodiment, one platform corresponds to one protrusion.

The gate electrode adopted in the present invention can be of any kind as used in a conventional FED, but preferably is a plurality of gate electrodes separate from one another or integrally made as a single gate electrode plate. The “plural gate electrodes” can be “annular gate electrodes,” where the gate electrodes are in a “one-to-one” or “one-to-plural” relationship with the plural electron emitters.

In order to gather electrons emitted from the electron emitters, and to isolate an influence resulting from the electrode at the top substrate over the electrode at the bottom substrate, the FED according to the present invention includes at least one electron-focusing plate having a plurality of openings, where the electron-focusing plate is located between the top substrate and the bottom substrate, so that the brightness of the pixels of the FED according to the present invention can be improved and that the circuit of the FED can be controlled more easily.

The number of the electron-focusing plates in between the top substrate and the bottom substrate are not to be limited. In fact, the location and the number of layers of the electron-focusing plates can be adjusted dependent on the manufacturing process. Besides, the arrangement of the openings of the electron-focusing plate is not limited, but preferably is in a formation of matrix M×N, where M and N are each an integer greater than zero. The shape of openings for the electron-focusing plate is not to be limited, but preferably is a square, circle, polygon, or ellipse. In still another embodiment of the present invention, the plural openings contained in an electron-focusing plate just correspond to the opening-pattern of the insulating layer.

Referring to the openings of the electron-focusing plate, where each individual opening is shaped like two bowls attaching to each other at the bottoms thereof, the dimension of each opening is not to be limited, or specifically the dimensions of the two bowls in each opening can be equal or not.

The electron-focusing plate used in the FED according to the present invention can be of any metallic materials or alloys, preferably of metallic materials or alloys having a surface capable of electron multiplication, such as silver-magnesium alloy, copper-beryllium alloy, copper-barium alloy, gold-barium alloy, gold-calcium alloy, tungsten-barium-gold alloy, or a combination thereof; or of metal oxides such as oxides of beryllium, oxides of magnesium, oxides of calcium, oxides of strontium, oxides of barium, or a combination thereof, so as to increase the number of electrons which excite the fluorescence, and as a result, enhance brightness and contrast of colors for the pixels as a whole.

The electron emitters according to the present invention may use any conventional electron emitting materials, but preferably is a carbon-based material, selected from the group of graphite, diamond, diamond-like carbon, carbon nanotube, fullerene (C₆₀), and the composite thereof. In one of the preferred embodiments of the present invention, a material of canbon nanotube is used for electron emitters, namely, a Carbon Nanotube (CNT) FED.

Further, in the FED according to the present invention the top substrate may include a black matrix layer which is closely engaged with the fluorescent layer, so as to shield light leak or to increase contrast. In the FED according to the present invention the bottom substrate may include a switch element connected with the at least one cathode electrode so as to drive the electron emitters on the protrusions of the cathode electrodes. The switch element here referred to can be of any conventional active or passive switch element, but preferably is a thin film transistor (TFT), thin film diode, or a matrix driving and scanning circuit.

The FED according to the present invention, via controlling accurately the elevations of the electron emitter and the gate electrode, as well as the driving distance between the electron emitter and the gate electrode can enhance a uniformity of electron emission and production rate so as to prevail in the market.

Other objects, advantages, and novel features of the present invention will become more apparent from the following detailed description when taken in conjunction with the accompanying drawings.

### BRIEF DESCRIPTION OF THE DRAWINGS

FIG. 1 is a sectional view of an FED according to the first embodiment of the present invention;

FIG. 2 is a sectional view of an FED according to the second embodiment of the present invention; and

FIG. 3 is a sectional view of an FED according to the third embodiment of the present invention.

### DETAILED DESCRIPTION OF THE PREFERRED EMBODIMENTS

Embodiment 1

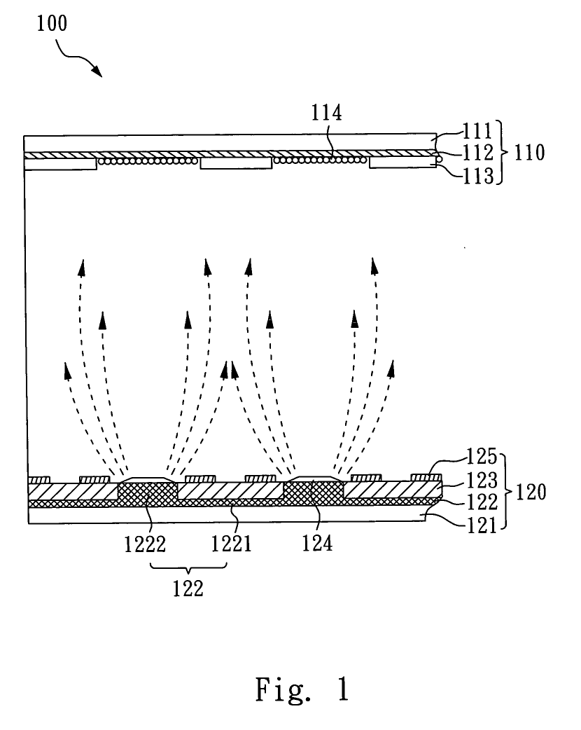

Referring to FIG. 1, a field emission display device (FED) 100 according to the first embodiment of the present invention includes a top substrate 110 and a bottom substrate 120, wherein the top substrate 110 has a transparent panel 111, an anode electrode 112, a black matrix layer 113, and a fluorescent layer 114. The fluorescent layer 114 according to the present invention, however, can be of phosphor lay or any like illumination layer. The transparent panel 111 can be made of glass or of any transparent material. The anode electrode 112 can be made of a transparent electric-conductive material such as indium tin oxide (ITO) or indium zinc oxide (IZO).

As shown in FIG. 1, the bottom substrate 120 includes a bottom panel 121, a cathode electrode 122, an insulating layer 123 having a plurality of circular matrix openings, electron emitters 124, and a gate electrode 125. The insulating layer 123 is made of a composition material of Al₂O₃ or MgO or SiO₂, and the electron emitters 124 are made of a composition material of carbon nanotube.

In the first embodiment of the present invention, the cathode electrode 122 is placed over the bottom panel 121 and includes a platform 1221 and a plurality of protrusions 1222, where the platform 1221 and the protrusions 1222 are all electric-conductive materials.

Further, the openings of the insulating layer 123 are just filled fully with the protrusions 1222 of the cathode electrode 122. As such, both the surface of the insulting layer 123 on the platform 1221 and the surface of the protrusions 1222 of the cathode electrode 122 have the same elevation. As shown in FIG. 1, annular gate electrodes 125 are located on the insulating layer 123, and the electron emitters 124 are located on the protrusions 1222 of the cathode electrode 122. In the first embodiment, the electron emitters 124 and the gate electrodes 125 have the same elevation.

In the first embodiment, control is made to vary the potential applied on the cathode electrode 122 and the gate electrodes 125 so as to activate the electron emitters 124 to emit electrons at a designated time. Besides, the electrons emitted from the electron emitters 124 are affected by the potential between the top substrate 110 and the bottom substrate 120 and as a result, move in an accelerated manner from the bottom substrate 120 toward the top substrate 110. When the electrons collide against the fluorescent layer 114 on the top substrate 110, a visible light is produced due to a reaction with the fluorescent material, whereby the visible light passes through the transparent panel 111 and thus can be seen by the naked eye.

In the first embodiment, the method for preparing the top substrate 110 of the FED 100 can be of any conventional in preparing top substrates of FEDs; whereas the method for preparing the bottom substrate 120 of the FED 100 can be a conventional screen printing process in preparing first the platform 1221 of the cathode electrode 122 and the insulating layer 123; and then the protrusions 1222 of the cathode electrode 122 where the protrusions 1222 fill fully in the openings of the insulating layer 123; and finally a flattening process is proceeded on the surface of the insulating layer 123 and the surface of the protrusion 1222 of the cathode electrode 122, so that the surface of the insulating layer 123 and the surface of the protrusion 1222 of the cathode electrode 122 will have the same elevation.

Based on the featured structure of the present invention, the bottom substrate 120 of the FED 100, as compared with conventional processes, can be prepared more easily, and as such, lowering the cost of manufacture.

It is noted that the method in preparing the FED 100 according to the present invention is not limited, and preferably can be any method in preparing FEDs, such as a screen printing process, sputtering process, coating process, lithographic process, or etching process, so as to form a structure of FED 100 according to the present invention.

Embodiment 2

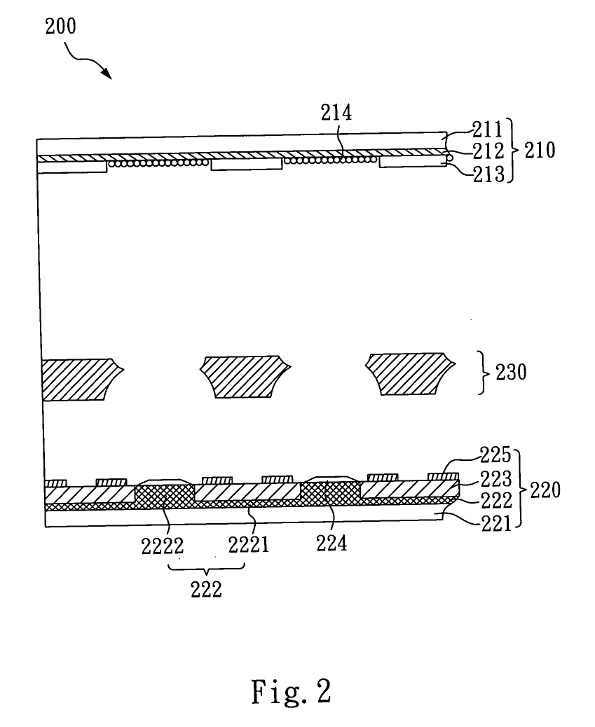

FIG. 2 shows a schematic view of an FED 200 according to a second embodiment of the present invention, comprising a top substrate 210, a bottom substrate 220 and an electron-focusing plate 230. In this embodiment the structures of the top and bottom substrates 210 and 220 are similar to those taught in the first embodiment, while the FEDs 100 and 200 according to the first and second embodiments of the invention differ only in that the latter is provided additionally with an electron-focusing plate 230 having a plurality of circular openings.

In the second embodiment of the present invention, the electron-focusing plate 230 can be of ferro-nickel alloy or silver-magnesium alloy capable of electron multiplication. Plural circular openings of the electron-focusing plate 230 just correspond to the circular openings at the insulating layer 223 of the bottom substrate 220. In addition, a negative electric field is applied to the electron-focusing plate 230 so as to enhance the effectiveness of gathering electrons emitted from the electron emitters 224 and to isolate an influence on the bottom substrate 220 caused by a high electric field of an anode electrode 212 on the top substrate 210.

As shown in FIG. 2, the openings of the electron-focusing plate 230 are shaped like two bowls attaching to each other at the bottoms, where the dimensions of the two bowls are equal or not equal to each other.

It is noted that the openings of the electron-focusing plate 230 are circular in shape, and that the shape or dimension of the openings are not to be limited.

Embodiment 3

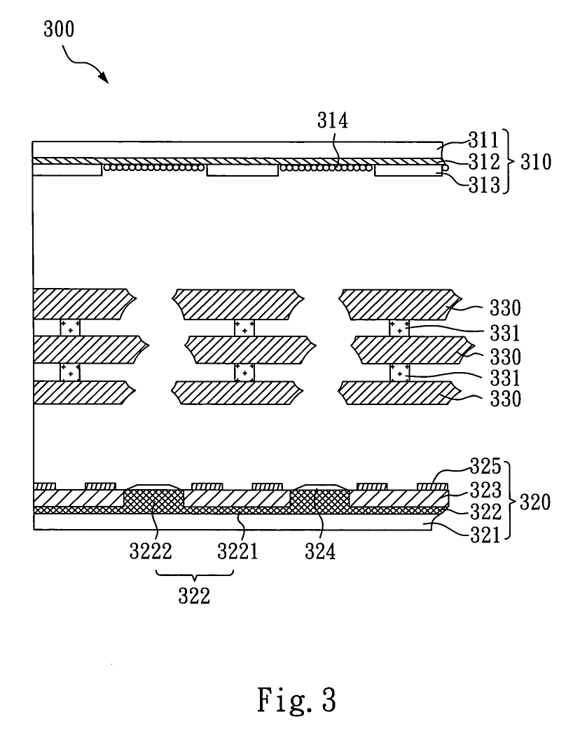

FIG. 3 shows a schematic view of an FED 300 according to a third embodiment of the present invention, comprising a top substrate 310, a bottom substrate 320, a plurality of electron-focusing plates 330, and insulating layers 331 interposed between the electron-focusing plates 330.

In the third embodiment the structure of the FED 300 is similar to that of the FED 200 in the second embodiment, with the exception that three electron-focusing plates 330 each having a plurality of circular openings, are disposed between the top and bottom substrates 310 and 320 and that two insulating layers 331 are disposed between the electron-focusing plates 330. The insulating layers 331 are provided for maintaining stability of the structure of multiple electron-focusing plates 330 and to avoid declination thereof.

The structures of the FEDs according to the above-mentioned embodiments of the present invention can enhance the uniformity of electron emission for every pixel, and through the help of the electron-focusing plates the number of electrons, which excite illumination of fluorescence, can be increased. As such, brightness and color contrast of the pixels can be improved so as to provide a screen of high-quality image.

Although the present invention has been explained in relation to its preferred embodiments, it is to be understood that many other possible modifications and variations can be made without departing from the scope of the invention as hereinafter claimed.

What is claimed is:

1. A field emission display, comprising:
a top substrate having a fluorescent layer and an anode electrode;
a bottom substrate;
at least one cathode electrode locating on a bottom substrate and having a platform and at least one protrusion, wherein each of the platform and the protrusion has a height different from each other;
an insulating layer, having an opening-pattern and locating on the platform of the cathode electrode, wherein the opening-pattern of the insulating layer includes at least one opening;
at least one gate electrode locating on the insulating layer having the opening-pattern; and
at least one electron emitter locating on the protrusion of the cathode electrode;
wherein the protrusion of the cathode electrode is located in the opening of the insulating layer having the opening-pattern.

2. The field emission display as claimed in claim 1, wherein the openings of the insulating layer are arranged in a form of matrix M×N, and M and N are each an integer greater than zero.

3. The field emission display as claimed in claim 1, wherein the shape of the openings of the insulating layer is at least one selected from the group consisting of a square, a circle, a polygon, an ellipse, and combination thereof.

4. The field emission display as claimed in claim 1, wherein the opening of the insulating layer is a groove.

5. The field emission display as claimed in claim 1, wherein the protrusions of the cathode electrodes can fully fill in the openings of the insulating layer.

6. The field emission display as claimed in claim 4, wherein the surface of the insulating layer has an elevation substantially the same as that of the surface of the protrusion of the cathode electrode.

7. The field emission display as claimed in claim 5, wherein the gate electrode and the electron emitter are at the same elevation.

8. The field emission display as claimed in claim 1, wherein the platform and the protrusion of the cathode electrode are of the same electric-conductive material.

9. The field emission display as claimed in claim 1, wherein the platform and the protrusion of the cathode electrode are of different electric-conductive materials.

10. The field emission display as claimed in claim 1, wherein the platform corresponds to one protrusion.

11. The field emission display as claimed in claim 1, wherein the platform corresponds to a plurality of protrusions.

12. The field emission display as claimed in claim 1, wherein the gate electrode comprises a plural of annular gate electrodes having openings.

13. The field emission display as claimed in claim 12, wherein the shape of the openings of the annular gate electrodes is same as that of the insulating layer.

14. The field emission display as claimed in claim 1, wherein the gate electrode is a gate electrode plate having a plural of openings.

15. The field emission display as claimed in claim 14, wherein the shape of the openings of the gate electrode is same as that of the insulating layer.

16. The field emission display as claimed in claim 12, wherein the plural of annular gate electrodes are integrally made as a single gate electrode plate.

17. The field emission display as claimed in claim 1, further comprising at least one electron-focusing plate having a plurality of openings, wherein the electron-focusing plate is located between the top substrate and the bottom substrate.

18. The field emission display as claimed in claim 17, wherein the openings of the electron-focusing plate are each shaped like two bowls attaching to each other at the bottoms thereof and the dimensions of the two bowls in each opening are equal.

19. The field emission display as claimed in claim 17, wherein the openings of the metal plate are each shaped like two bowls attaching to each other at the bottoms thereof and the dimensions of the two bowls in each opening are not equal.

20. The field emission display as claimed in claim 17, wherein the electron-focusing plate is made of an alloy.

21. The field emission display as claimed in claim 1, wherein the electron emitter is made of a carbon-based material, selected from a group consisting of graphite, diamond, diamond-like carbon, carbon nanotube, fullerene (C60), and the composite thereof.

22. The field emission display as claimed in claim 1, wherein the filed emission display is a Carbon Nanotube (CNT) FED.

23. The field emission display as claimed in claim 1, wherein the top substrate includes a black matrix layer which is closely engaged with the fluorescent layer.
